(19) United States
(12) Patent Application Publication
(10) Pub. No.: US 2021/0054914 A1
(43) Pub. Date: Feb. 25, 2021

(54) DAMPER DEVICE

(71) Applicant: AISIN AW INDUSTRIES CO., LTD., Echizen-shi, Fukui (JP)

(72) Inventors: Makoto YAMAGUCHI, Echizen-shi (JP); Hiroki TAKAYANAGI, Echizen-shi (JP); Kouhei SHIMIZU, Echizen-shi (JP); Akiyoshi KATO, Echizen-shi (JP); Yoichi OI, Anjo-shi (JP)

(73) Assignee: AISIN AW INDUSTRIES CO., LTD., Echizen-shi, Fukui (JP)

(21) Appl. No.: 17/044,056

(22) PCT Filed: Mar. 29, 2019
(86) PCT No.: PCT/JP2019/014161

§ 371 Date: Sep. 30, 2020

(30) Foreign Application Priority Data
Mar. 30, 2018 (JP) 2018-067722

(51) Int. Cl. F16H 45/02; F16H 1/28

(52) U.S. Cl. CPC F16H 45/02; F16F 15/134; F16H 1/28

(57) ABSTRACT

A damper device includes a plurality of rotational elements including an input element and an output element; an elastic body that transmits a torque between the input and the output elements; and a rotary inertia mass damper with a mass body rotating in accordance with a relative rotation between a first rotational element which is one of the rotational elements and a second rotational element different from the first rotational element. The rotary inertia mass damper includes a sun gear that rotates integrally with the first rotational element, pinion gears rotatably supported by the second rotational element, and a ring gear that meshes with the pinion gears and works as the mass body. The second rotational element includes a plurality of ring gear supporting portions arranged at intervals in a circumferential direction so as to restrict a movement of the ring gear in an axial direction of the damper device.

### TECHNICAL FIELD

The present disclosure relates to a damper device including an elastic body arranged to transmit a torque between an input element and an output element, and a rotary inertia mass damper.

### BACKGROUND

A conventionally known torque converter includes a lockup clutch, a torsional vibration damper, and a rotary inertia mass damper (power transmission mechanism) with a planetary gear (as shown in, for example, Patent Literature 1). The torsional vibration damper of the torque converter includes two cover plates (input element) respectively coupled with a lockup piston by means of a plurality of bearing journals, a sun gear disposed between the two cover plates in an axial direction thereof so as to work as a driven side transmission element (output element), and springs (elastic bodies) that transmit a torque between the cover plates and the sun gear. In addition to the sun gear, the rotary inertia mass damper further includes a plurality of pinion gears (planet gears) rotatably supported by the cover plates or a carrier via a bearing journals so as to mesh with the sun gear, and a ring gear that meshes with the plurality of pinion gears. An entire side face of the ring gear or the mass body is supported from both sides in the axial direction by the two cover plates or the carrier.

Further, a conventionally known damper device includes a plurality of rotational elements including an input element and an output element; an elastic body arranged to transmit a torque between the input element and the output element; and a rotary inertia mass damper that includes a sun gear arranged to rotate integrally with the first element that is one of the plurality of rotational elements, a carrier that rotatably supports a plurality of pinion gears and is configured to rotate integrally with the second element different from the first rotational element, and a ring gear that meshes with the plurality of pinion gears and works as an mass body. In the damper device, a movement of the ring gear of the rotary inertia mass damper in the axial direction is restricted by either the plurality of pinion gears or washers disposed on both sides of each of the pinion gears in the axial direction.

### CITATION LIST

### Patent Literature

PTL1: Japanese Patent No. 3299510

PTL2: WO 2016/208767

### SUMMARY

In the rotary inertia mass damper described in Patent Document 1, in which the entire side face of the ring gear or the mass body is supported from both sides by the two cover plates or the carrier, vibration damping performance may be deteriorated by a hysteresis of the rotary inertia mass damper due to a difference in a rotational speed between the ring gear and the cover plate. On the other hand, in the rotary inertia mass damper described in Patent Document 2, in which a movement of the ring gear or a mass body in an axial direction is restricted by the pinion gears or the washers, the hysteresis of the rotary inertia mass damper is favorably reduced, such that the vibration damping performance may be improved. However, if the ring gear of the rotary inertia mass damper is axially supported by the pinion gear, structures of the ring gear and the pinion gear becomes complicated and assemblability of the damper device with the rotary inertia mass damper may be deteriorated, thereby resulting in a cost increase. Further, if the movement of the ring gear in the axial direction is restricted by the washer, flexibility in setting an axial lengths of the pinion gear and the ring gear may decrease.

A subject matter of the present disclosure is to suppress the cost increase of the damper device with the rotary inertia mass damper while ensuring vibration damping performance of the damper device.

A damper device of the present disclosure is configured to include a plurality of rotational elements including an input element to which a torque from an engine is transmitted and an output element; an elastic body arranged to transmit a torque between the input element and the output element; and a rotary inertia mass damper with a mass body rotating in accordance with a relative rotation between a first rotational element that is one of the plurality of rotational elements and a second rotational element different from the first rotational element. The rotary inertia mass damper includes a sun gear arranged to rotate integrally with the first rotational element, a plurality of pinion gears rotatably supported by the second rotational element, and a ring gear that meshes with the plurality of pinion gears and works as the mass body. The second rotational element includes a plurality of ring gear supporting portions arranged at intervals in a circumferential direction so as to restrict a movement of the ring gear in an axial direction of the damper device.

In the damper device of the present disclosure, the plurality of pinion gears of the rotary inertia mass damper is rotatably supported by the second rotational element in which the plurality of ring gear supporting portions is arranged at intervals in the circumferential direction so as to restrict a movement of the ring gear in an axial direction of the damper device. This enables the movement of the ring gear in the axial direction to be restricted while reducing a contact area between the ring gear and the plurality of ring gear support portions, thereby suppressing an increase in a hysteresis of the rotary inertia mass damper and ensuring vibration damping performance. Further, a restriction of the movement of the ring gear in the axial direction by the second rotating element prevents structures of the ring gear and the pinion gear from becoming complicated and an assemblability of the damper device with the rotary inertia mass damper from being deteriorated. As a result, the cost increase of the damper device with the rotary inertia mass damper is suppressed while favorably ensuring vibration damping performance of the damper device.

### BRIEF DESCRIPTION OF DRAWINGS

FIG. 1 is a schematic configuration diagram illustrating a starting device including a damper device according to the present disclosure;

FIG. 2 is a sectional view illustrating the damper device according to the present disclosure;

FIG. 3 is a front view illustrating the damper device according to the present disclosure;

FIG. 4 is an enlarged view illustrating a rotary inertia mass damper of the damper device according to the present disclosure;

FIG. 5 is an enlarged view illustrating a rotary inertia mass damper of the damper device according to the present disclosure;

FIG. 6 is a plan view illustrating a driven member and an internal gear included in the damper device according to the present disclosure;

FIG. 7 is a schematic configuration diagram illustrating a starting device including another damper device according to the present disclosure;

FIG. 8 is a front view illustrating the another damper device according to the present disclosure;

FIG. 9 is an enlarged view illustrating yet another damper device according to the present disclosure; and

FIG. 10 is an enlarged view illustrating the yet another damper device according to the present disclosure.

### DESCRIPTION OF EMBODIMENTS

The following describes embodiments of the disclosure with reference to drawings.

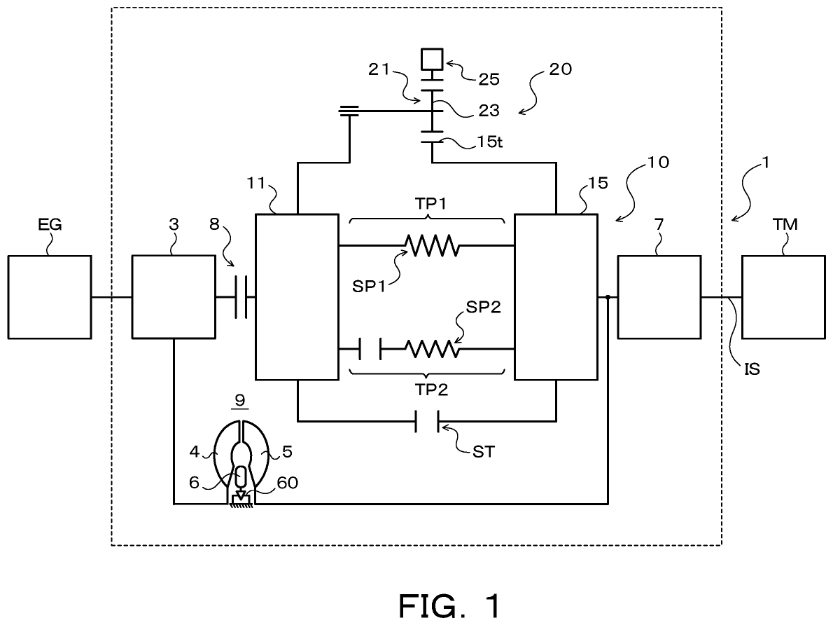

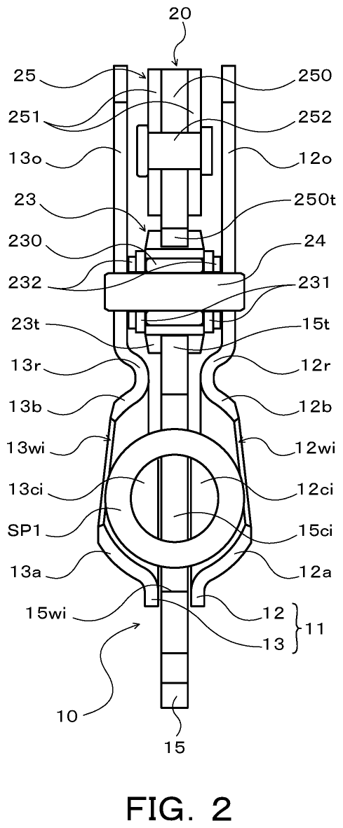

FIG. 1 is a schematic configuration diagram illustrating a starting device 1 including a damper device 10 according to the present disclosure. FIG. 2 is a sectional view illustrating the damper device 10. The starting device 1 shown in FIG. 1 is mounted on a vehicle equipped with an engine (internal combustion engine) EG as a driving source. The damper device 10 includes, in addition to the damper device 10, a front cover 3 as an input member coupled with a crankshaft of the engine EG to receive a torque transmitted from the engine EG; a pump impeller (input-side fluid transmission element) 4 fixed to the front cover 3; a turbine runner (output-side fluid transmission element) 5 arranged to be rotatable coaxially with the pump impeller 4; a damper hub 7 as an output member coupled with the damper device 10 and fixed to an input shaft IS of a transmission TM, which is either an automatic transmission (AT) or a continuously variable transmission (CVT); and a lockup clutch 8, for example.

In the description below, an “axial direction” basically denotes an extending direction of a center axis (axial center) of the starting device 1 or the damper device 10, unless otherwise specified. A “radial direction” basically denotes a radial direction of the starting device 1, the damper device 10 or a rotational element of the damper device 10 and the like or more specifically an extending direction of a straight line extended from the center axis of the starting device 1 or the damper device 10 in a direction perpendicular to the center axis (in a radial direction), unless otherwise specified. A “circumferential direction” basically denotes a circumferential direction of the starting device 1, the damper device 10 or the rotational element of the damper device and the like, or, in other words, a direction along a rotating direction of the rotational element, unless otherwise specified.

The pump impeller 4 includes a pump shell (not shown) closely fixed to the front cover 3 and a plurality of pump blades (not shown) arranged on an inner surface of the pump shell. The turbine runner 5 includes a turbine shell (not shown) and a plurality of turbine blades (not shown) arranged on an inner surface of the turbine shell. An inner circumferential portion of the turbine shell is fixed to the damper hub 7 by means of a plurality of rivets. The pump impeller 4 and the turbine runner 5 are opposed to each other. A stator 6 (see FIG. 1) is coaxially arranged between the pump impeller 4 and the turbine runner 5 so as to rectify the flow of the hydraulic oil (working fluid) from the turbine runner 5 to the pump impeller 4. The stator 6 includes a plurality of stator blades (not shown). A rotating direction of the stator 6 is set to only one direction by a one-way clutch 60 (see FIG. 1). The pump impeller 4, the turbine runner 5 and the stator 6 form a torus (annular flow path) to circulate the hydraulic oil and serves as a torque converter (fluid transmission device) with a torque amplification function. The stator 6 and the one-way clutch 60 may be omitted from the starting device 1, and the pump impeller 4 and the turbine runner 5 may serve as fluid coupling.

The lockup clutch 8 performs lockup for connecting the front cover 3 and the damper hub 7 via the damper device 10 and releases the lockup. In the present embodiment, the lockup clutch 8 is a hydraulic single-plate clutch that includes a lockup piston to which a friction material is attached. The lockup piston of the lockup clutch 8 is axially movably fitted to the damper hub 7 so as to be located inside the front cover 3 on an opposite side of the turbine runner 5 with respect to the damper device 10. The lockup piston faces an inner wall surface of the front cover 3 on the engine EG side. The lockup clutch 8 may be a hydraulic multi-plate clutch.

As shown in FIG. 1 and FIG. 2, the damper device 10 includes a drive member (input element) 11, and a driven member (output element) 15 that is an annular plate member, as rotational elements. Further, the damper device 10 also includes a plurality of (for example, six in the present embodiment) first springs (first elastic bodies) SP1 arranged to work in parallel to one another and to transmit the torque between the drive member 11 and the driven member 15, and a plurality of (for example, three in the present embodiment) second springs (second elastic bodies) SP2 arranged to work in parallel to one another and to transmit the torque between the drive member 11 and the driven member 15.

More specifically, as shown in FIG. 1, the damper device 10 includes, between the drive member 11 and the driven member 15, a first torque transmission path TP1 that includes the plurality of first springs SP1, and second torque transmission path TP2 that includes the plurality of second springs SP2 and is provided in parallel to the first torque transmission path TP1. In the present embodiment, the plurality of second springs SP2 of the second torque transmission path TP2 works in parallel to the first springs SP1 of the first torque transmission path TP1 when either an input torque to the drive member 11 or a torque (driven torque) applied to the driven member 15 from an axle side reaches a predetermined torque (first threshold value) T1 smaller than a torque T2 (second threshold value) corresponding to a maximum torsion angle θmax of the damper device 10 and a torsion angle of the drive member 11 relative respect to the driven member 15 becomes equal to or larger than a predetermined angle θref. Thus, the damper device 10 has two-step (two-stage) damping characteristics.

In the present embodiment, straight coil springs formed from a metal material helically wound to have an axial center extended straight under no application of a load are employed as the first and the second springs SP1 and SP2. This configuration enables the first and the second springs SP1 and SP2 to be more appropriately stretched and contracted along the axial center, compared with a configuration employing arc coil springs. As a result, this configuration reduces a hysteresis, more specifically, a difference between a torque transmitted from the first springs SP1 and the like to the driven member 15 in a process of increasing a relative displacement between the drive member 11 (input element) and the driven member 15 (output element) and a torque transmitted from the first springs SP1 and the like to the driven member 15 in a process of decreasing the relative displacement between the drive member 11 and the driven member 15. Arc coil springs may be employed as at least any of the first and the second springs SP1 and SP2.

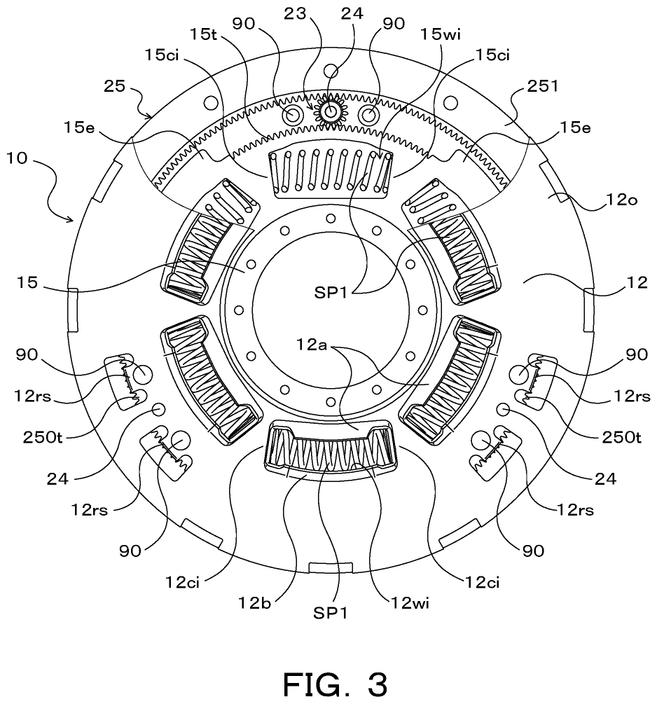

As shown in FIG. 2, the drive member 11 of the damper device 10 includes an annular first input plate (plate member) 12 that is coupled with the lockup piston of the lockup clutch 8; and an annular second input plate (plate member) 13 that is coupled with the first input plate 12 by means of a plurality of rivets (fastening members) 90 (see FIG. 3) so as to oppose to the first input plate 12. Accordingly, the drive member 11 or more specifically the first and the second input plate 12, 13 rotate integrally with the lockup piston, and the front cover 3 (engine EG) and the drive member 11 of the damper device 10 are coupled with each other by an engagement of the lockup clutch 8.

The first input plate 12 is an annular pressed product formed by pressing a steel plate and the like. As shown in FIGS. 2 and 3, the first input plate 12 includes a plurality of (for example, six in the present embodiment) inner spring accommodating windows (first accommodation windows) 12wi respectively extending in an arc shape and arranged at intervals (at equal intervals) in the circumferential direction; a plurality (for example, six in the present embodiment) of spring support portions 12a extending along an inner edge of each inner spring accommodating window 12wi; a plurality (for example, six in the present embodiment) of spring support portions 12b extending along an outer edge of each inner spring accommodating window 12wi; and a plurality (for example, twelve in the present embodiment) of inner spring contact portions 12ci disposed on both sides in the circumferential direction of each inner spring accommodating window 12wi. As seen from FIG. 3, each of the inner spring accommodation windows 12wi has a circumferential length corresponding to a natural length of the first spring SP1.

Further, the first input plate 12 includes a plurality (for example, three in the present embodiment) of outer spring accommodating windows (second accommodation windows) extending in an arc shape and arranged at intervals (at equal intervals) in the circumferential direction radially outside the corresponding inner spring accommodating windows 12wi; a plurality of (for example, three in the present embodiment) outer spring support portions extending along an outer edge of each outer spring accommodating window; and a plurality of (for example, six in the present embodiment) outer spring contact portions disposed on both sides in the circumferential direction of each outer spring accommodating window (all are not shown). Each of the outer spring accommodating windows has a circumferential length longer than a natural length of the second spring SP2. Further, as shown in FIGS. 2 and 3, an outer peripheral portion 12o of the first input plate 12 is formed in a flat and annular shape and is connected to an inner peripheral side portion via an annular bent portion 12r.

The second input plate 13 is an annular pressed product formed by pressing a steel plate and the like. As shown in FIGS. 2 and 3, the second input plate 13 includes a plurality of (for example, six in the present embodiment) inner spring accommodating windows (first accommodation windows) 13wi respectively extending in an arc shape and arranged at intervals (at equal intervals) in the circumferential direction; a plurality (for example, six in the present embodiment) of spring supporting portions 13a extending along an inner edge of each inner spring accommodating window 13wi; a plurality (for example, six in the present embodiment) of spring support portions 13b extending along an outer edge of each inner spring accommodating window 13wi; and a plurality (for example, twelve in the present embodiment) of inner spring contact portions 13ci disposed on both sides in the circumferential direction of each inner spring accommodating window 13wi. Each of the inner spring accommodation windows 13wi has a circumferential length corresponding to a natural length of the first spring SP1 as well as each of the inner spring accommodating window 12wi of the first input plate 12.

Further, the second input plate 13 includes a plurality (for example, three in the present embodiment) of outer spring accommodating windows (second accommodation windows) extending in an arc shape and arranged at intervals (at equal intervals) in the circumferential direction radially outside the corresponding inner spring accommodating windows 13wi; a plurality of (for example, three in the present embodiment) spring support portions extending along an outer edge of each outer spring accommodating window; and a plurality of (for example, six in the present embodiment) outer spring contact portions disposed on both sides in the circumferential direction of each outer spring accommodating window (all are not shown). Each of the outer spring accommodating windows has a circumferential length longer than a natural length of the second spring SP2. Further, as shown in FIGS. 2 and 3, an outer peripheral portion 13o of the second input plate 13 is formed in a flat and annular shape and is connected to an inner peripheral side portion via an annular bent portion 13r. In the present embodiment, the first and the second input plates 12 and 13 with the same shape are adopted. This enables number of types of parts to be reduced.

The driven member (output plate) 15 is a plate-like annular pressed product formed by pressing a steel plate and the like. The driven member 15 is disposed between the first and the second input plates 12 and 13 in the axial direction and fixed to the damper hub 7 by means of a plurality of rivets. As shown in FIGS. 2 and 3, the driven member 15 includes a plurality of (for example, six in the present embodiment) inner spring holding windows (first holding windows) 15wi arranged at intervals (at equal intervals) in the circumferential direction, a plurality of (for example, twelve in the present embodiment) inner spring contact portions 15ci disposed on both sides in the circumferential direction of each inner spring holding window 15wi; a plurality of (for example, three in the present embodiment) outer spring holding windows (not shown, second holding windows) disposed radially outside the corresponding inner spring holding window 15wi; and a plurality of (for example, six in the present embodiment) outer spring contact portions disposed on both sides in the circumferential direction of each outer spring holding window. As seen from FIG. 3, each of the inner spring holding windows 15wi has a circumferential length corresponding to the natural length of the first spring SP1. Each of the outer spring holding windows has a circumferential length corresponding to the natural length of the second spring SP2.

One first spring SP1 is disposed (fitted) in each of the inner spring holding windows 15wi of the driven member 15. The plurality of first springs SP1 is arranged on an identical circumference. The inner spring contact portions 15ci disposed on both sides in the circumferential direction of each inner spring holding window 15wi contact one end or the other end of the first spring SP1 in the inner spring holding window 15wi. Further, one second spring SP2 is disposed (fitted) in each of the outer spring holding windows of the driven member 15. The plurality of second springs SP2 is arranged on an identical circumference outside the plurality of first springs SP1 in the radial direction of the driven member 15. The outer spring contact portions disposed on both sides in the circumferential direction of each outer spring holding window contact one end or the other end of the second spring SP2 in the outer spring holding window.

The first and the second input plates 12, 13 of the drive member 11 are coupled with each other by means of the plurality of rivets 90 so as to hold the driven member 15, the plurality of first springs SP1, and the plurality of second springs SP2 from both sides in the axial direction of the damper device 10. Thus, side portions of each of the first springs SP1 are respectively accommodated in the corresponding inner spring accommodating windows 12wi, 13wi of the first and the second input plates 12 and 13 and may be supported (guided) from a radially inner side by the spring supporting portions 12a, 13a. Further, each of the first springs SP1 can be supported (guided) by the spring supporting portions 12b, 13b of the first and the second input plates 12 and 13 located on an outer side in the radial direction. Further, in a mounted state of the damper device 10, the inner spring contact portions 12ci disposed on both sides in the circumferential direction of each inner spring accommodating window 12wi and the inner spring contact portions 13ci disposed on both sides in the circumferential direction of each inner spring accommodating window 13wi are in contact with one end or the other end of the first spring SP1 in the inner spring housing windows 12wi and 13wi. As a result, the drive member 11 and the driven member 15 are connected via the plurality of first springs SP1.

Further, side portions of each of the second springs SP2 are respectively accommodated in the corresponding outer spring accommodating windows of the first and the second input plates 12 and 13 and may be supported (guided) from a radially inner side by the spring supporting portions. In the mounted state of the damper device 10, each of the second springs SP2 is located at a substantially central portion in the circumferential direction of the outer spring accommodating window and does not contact with any of the outer spring contact portions of the first and the second input plates 12 and 13. One end of the second spring SP2 comes into contact with one of the outer spring contact portions disposed on both sides of the corresponding outer spring accommodating window of the first and the second input plates 12 and 13 when either the input torque (driving torque) to the drive member 11 or the torque (driven torque) applied to the driven member 15 from the axle side reaches the torque T1 and the torsion angle of the drive member 11 with respect to the driven member 15 becomes equal to or larger than the predetermined angle θref.

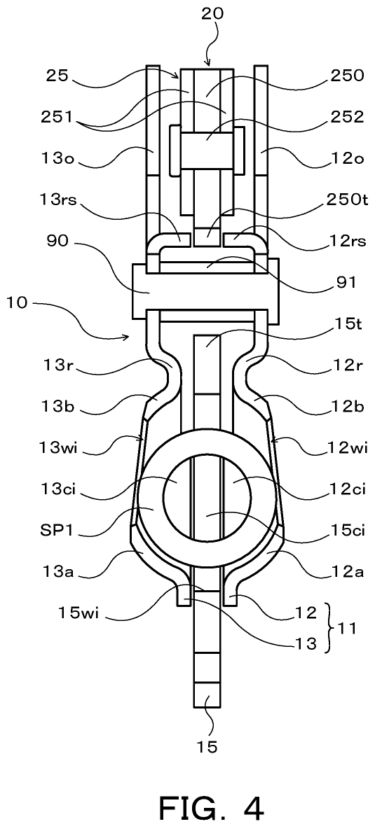

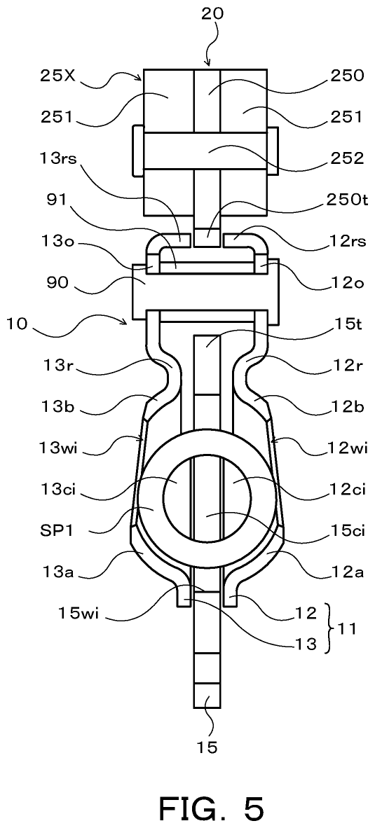

The damper device 10 further includes a stopper ST configured to restrict a relative rotation between the drive member 11 and the driven member 15. When the input torque to the drive member 11 reaches the torque T2 corresponding to the maximum torsion angle θmax of the damper device 10, the stopper ST restricts the relative rotation between the drive member 11 and the driven member 15, thereby restricting deflections of all of the first and the second springs SP1 and SP2. In the present embodiment, the stopper ST includes a plurality of rivets 90 and spacers 91 (see FIGS. 4 and 5) that couple the first and the second input plates 12 and 13 of the drive member 11, and a protrusion 15e (see FIG. 3) formed in the driven member 15. That is, the relative rotation between the drive member 11 and the driven member 15 is restricted when at least one of the plurality of rivets 90 comes into contact with an end in the circumferential direction of the corresponding protrusion 15e of the driven member 15.

Additionally, as shown in FIGS. 1 and 2, the damper device 10 includes a rotary inertia mass damper 20 that is arranged parallel to both the first torque transmission path TP1 including the plurality of first springs SP1 and the second torque transmission path TP2 including the plurality of second springs SP2. In the present embodiment, the rotary inertia mass damper 20 includes a single pinion-type planetary gear 21 disposed between the drive member 11 or the input element of the damper device 10 and the driven member 15 or the output element of the damper device 10.

The planetary gear 21 is configured by the driven member 15 that includes a plurality of outer teeth 15t in an outer circumference thereof so as to work as a sun gear of the rotary inertia mass damper 20 (planetary gear 21); the first and the second input plate members 12, 13 that rotatably support a plurality of (for example, three in the present embodiment) pinion gears 23 respectively meshing with the outer teeth 15t so as to work as a carrier; and a ring gear 25 that is disposed concentrically with the driven member 15 (outer teeth 15t) or the sun gear. In a fluid chamber 9, the driven member 15 or the sun gear, the plurality of pinion gears 23 and the ring gear 25 at least partially overlap with the first and the second springs SP1 and SP2 in the axial direction as viewed in the radial direction of the damper device 10. This configuration shortens not only an axial length of the damper device 10, but also that of the rotary inertia mass damper 20.

As shown in FIGS. 2 and 3, the outer teeth 15t that configures a spur gear with a straight tooth trace extending in parallel to the axial center of the driven member 15 and are formed on a plurality of predetermined portions of an outer circumferential surface (outer circumferential portion) of the driven member 15 at intervals (at equal intervals) in the circumferential direction. Further, in the present embodiment, the outer teeth 15t are located radially outside the inner spring accommodating windows 15wi that is, the first springs SP1 that transmit the torque between the drive member 11 and the driven member 15. The outer teeth 15t may be formed on an entire outer circumference of the driven member 15.

An outer peripheral portion 12o of the first input plate 12 and an outer peripheral portion 13o of the second input plate 13, that form the carrier of the planetary gear 21, are axially opposed to each other at an interval, and rotatably supports the plurality of pinion gears 23 on an outer side in the radial direction of the driven member 15 so as to be arranged at equal intervals in the circumferential direction. That is, the outer peripheral portion 12o of the first input plate 12 and the outer peripheral portion 13o of the second input plate 13 respectively support corresponding ends of the pinion shafts 24 inserted into the pinion gears 23. In the present embodiment, one rivet 90 for fastening the first and second input plates 12 and 13 is arranged on each of both sides of each pinion shaft 24 in the circumferential direction of the first and second input plates 12 and 13.

As shown in FIG. 2, the pinion gear 23 is a spur gear with outer teeth 23t. A tooth width of the pinion gear 23 is defined to be larger than a tooth width of the outer teeth 15t, that is, a plate thickness of the driven member 15. A plurality of needle bearings 230 are disposed between an inner peripheral surface of the pinion gear 23 and an outer peripheral surface of the pinion shaft 24. Further, a pair of large-diameter washers 231 with a diameter smaller than that of a root circle of the outer teeth 23t is arranged on both sides of each pinion gear 23 in the axial direction. A pair of small-diameter washers 232 with a smaller diameter than the large-diameter washer 231 is arranged between the large-diameter washer 231 and the first or the second input plates 12 and 13.

As shown in FIGS. 2 and 3, the ring gear 25 of the planetary gear 21 includes an annular internal gear 250, two weight bodies 251 arranged so as to be in contact with corresponding ones of both side faces of the internal gear 250, and a plurality of rivets 252 for fixing the internal gear 250 and the weight bodies 251 to each other. The internal gear 250, the weight bodies 251, and the plurality of rivets 252 are integrated so as to work as a mass body (inertial mass body) of the rotary inertia mass damper 20. The ring gear 25 is arranged on an outermost periphery of the planetary gear 21 and used as the mass body of the rotary inertia mass damper 20, such that a moment of inertia of the ring gear 25 can be increased and vibration damping performance of the rotary inertia mass damper 20 can be improved.

The internal gear 250 is an annular pressed product formed by pressing a steel plate and the like. In the present embodiment, the internal gear 250 is a spur gear in which inner teeth 250t with tooth trace extending parallel to an axis thereof are formed on an entire inner peripheral surface. The internal teeth 250t may be formed on an inner peripheral surface of the internal gear 250 on a plurality of locations defined on an inner peripheral surface of the internal gear 250 at intervals (at equal intervals) in the circumferential direction. Further, a tooth width of the internal gear 250 is smaller than the tooth width of the pinion gear 23, and is substantially the same as the tooth width of the outer teeth 15t, that is, the plate thickness of the driven member 15. The weight body 251 is also an annular pressed product formed by pressing a steel plate and the like. In the present embodiment, the weight body 251 is an annular member with a concave cylindrically shaped inner peripheral surface and has an outer diameter substantially the same as an outer diameter of the internal gear 250 and an inner diameter greater than a radius of a root circle of the internal tooth 250t. The weight body 251 may include a plurality of segments formed by dividing the above annular member and fixed to the internal gear 250 via the rivets 252.

Further, in the damper device 10, a movement of the ring gear 25 in the axial direction is restricted by a portion of the first and the second input plates 12 and 13. That is, as shown in FIGS. 3 and 4, the first input plate 12 includes a plurality of (for example, six in the present embodiment) ring gear support portions 12rs arranged at intervals in the circumferential direction so as to close to the corresponding pinion shaft 24 and the rivet 90. The second input plate 13 includes a plurality of (for example, six in the present embodiment) ring gear support portions 13rs arranged at intervals in the circumferential direction so as to close to the corresponding pinion shaft 24 and the rivet 90.

In the present embodiment, each of the ring gear support portions 12rs of the first input plate 12 is bent by pressing so as to extend (protrude) in the axial direction toward the second input plate 13 on a radially outer side of a rivet hole into which the rivet 90 is inserted. Each of the ring gear support portions 13rs of the second input plate 13 is bent by pressing so as to extend (protrude) in the axial direction toward the first input plate 12 on a radially outer side of a rivet hole into which the rivet 90 is inserted.

In the mounting state of the damper device 10 in which the outer teeth 23t of each pinion gear 23 and the inner teeth 250t of the ring gear 25 mesh with each other, an end face or a contact portion of each of the ring gear support portions 12rs and 13rs opposes to side faces of the inner teeth 250t of the ring gear 25 with a slight clearance so as to be capable of contacting with the side faces of the inner teeth 250t. In the mounting state of the damper device 10, an outer peripheral surface of each of the ring gear support portions 12rs and 13rs is located slightly inward in the radial direction from tooth bottoms of the inner teeth 250t of the ring gear 25. The ring gear support portions 12rs and 13rs may be protrusions (dowels) that axially protrude from the corresponding one of the first and second input plates 12 and 13 toward the other so as to be capable of contacting with the ring gear 25 (the side faces of the internal teeth 250t).

The following describes an operation of the damper device 10 configured as above.

When the lockup by the lockup clutch 8 is released in the starting device 1, as seen from FIG. 1, the torque (power) transmitted from the engine EG to the front cover 3 is transmitted to the input shaft IS of the transmission TM via a path of the pump impeller 4, the turbine runner 5 and the damper hub 7. When the lockup is performed by the lockup clutch 8 of the starting device 1, on the other hand, the torque transmitted from the engine EG to the drive member 11 via the front cover 3 and the lockup clutch 8 is transmitted to the driven member 15 and the damper hub 7 via the first torque transmission path TP1 including the plurality of first springs SP1, and the rotary inertia mass damper 20 while the input torque and the like is less than the torque T1 and the torsion angle of the drive member 11 with respect to the driven member 15 is less than the predetermined angle θref.

When the drive member 11 is rotated (twisted) with respect to the driven member 15 at this time, the plurality of first springs SP1 is deflected and the ring gear 25 or the mass body is rotated (oscillated) about the axial center in accordance with the relative rotation of the drive member 11 to the driven member 15. When the drive member 11 is rotated (oscillated) with respect to the driven member 15, a rotational speed of the drive member 11, that is, the first and the second input plates 12 and 13 or the carrier that is an input element of the planetary gear 21 becomes higher than a rotational speed of the driven member 15 or the sun gear. In such a state, a rotational speed of the ring gear 25 is increased by an action of the planetary gear 21, such that the ring gear 25 is rotated at the higher rotational speed than the rotational speed of the drive member 11. This causes an inertia torque to be applied from the ring gear 25 that is the mass body of the rotary inertia mass damper 20 to the driven member 15 that is the output element of the damper device 10 via the pinion gears 23, thereby damping a vibration of the driven member 15.

More specifically, when the first springs SP1 work in parallel to the rotary inertia mass damper 20, the torque (average torque) transmitted from the plurality of first springs SP1 (first torque transmission path TP1) to the driven member 15 depends on (is proportional to) a displacement (amount of deflection or torsion angle) of the first springs SP1. The torque transmitted from the rotary inertia mass damper 20 to the driven member 15, on the other hand, depends on (is proportional to) a difference in angular acceleration between the drive member 11 and the driven member 15, i.e., a second order differential value of the displacement of the first springs SP1 between the drive member 11 and the driven member 15. On the assumption that the input torque transmitted to the drive member 11 of the damper device 10 is periodically vibrated, a phase of a vibration transmitted from the drive member 11 to the driven member 15 via the plurality of first springs SP1 is accordingly shifted by 180 degrees from a phase of a vibration transmitted from the drive member 11 to the driven member 15 via the rotary inertia mass damper 20. As a result, in the damper device 10, one of the vibration transmitted from the plurality of first springs SP1 to the driven member 15 and the vibration transmitted from the rotary inertia mass damper 20 to the driven member 15 cancels at least a part of the other, such that the vibration of the driven member 15 can be favorably damped. The rotary inertia mass damper 20 is configured to mainly transmit the inertia torque between the drive member 11 and the driven member 15 but not to transmit an average torque.

When the input torque and the like becomes equal to or greater than the torque T1 and the torsion angle of the drive member 11 with respect to the driven member 15 becomes equal to or greater than the predetermined angle θref, one end portion of each second spring SP2 contacts to one of the outer spring contact portions disposed on both sides of the corresponding outer spring accommodating windows of the first and second input plates 12 and 13. As a result, the torque transmitted to the drive member 11 is transmitted to the driven member 15 and the damper hub 7 via the first torque transmission path TP1, the second torque transmission path TP2 including the plurality of second springs SP2 and the rotary inertia mass damper 20 until the input torque and the like reaches the torque T2 and the relative rotation between the drive member 11 and the driven member 15 is restricted by the stopper ST. That is, in the damper device 10, the plurality of second springs SP2 do not transmit torque (do not deflect) until they contact both the corresponding outer spring contact portion of the driven member 15 and the outer spring contact portions of the first and second input plates 12 and 13. The plurality of second springs SP2 works in parallel to the first spring SP1 as the relative torsion angle between the drive member 11 and the driven member 15 increases. Accordingly, rigidity of the damper device 10 is increased in response to an increase in the relative torsion angle between the drive member 11 and the driven member 15, such that a large torque can be transmitted by the first and second springs SP1 and SP2 that work in parallel and an impact torque and the like can be received.

Further, in the damper device 10, at least one of the end faces (contact portions) of the plurality of ring gear support portions 12rs and 13rs formed in each of the first and second input plates 12, 13 so as to protrude in the axial direction at intervals in the circumferential direction comes into contact with the side faces of the inner teeth 250t of the ring gear 25 of the rotary inertia mass damper 20, thereby restricting the movement of the ring gear 25 in the axial direction. In the damper device 10, the ring gear 25 contacts only the ring gear support portions 12rs and 13rs in the axial direction, and does not come into contact with any member other than the first and second input plates 12 and 13 that include the ring gear support portions 12rs and 13rs. As a result, the movement of the ring gear 25 in the axial direction can be restricted while reducing a contact area between the ring gear 25 and the plurality of ring gear support portions 12rs and 13rs. This suppresses an increase in a hysteresis of the rotary inertia mass damper 20, more specifically a difference between the torque transmitted from the rotary inertia mass damper 20 to the driven member 15 in the process of increasing the relative displacement between the drive member 11 or the carrier and the driven member 15 or the sun gear and the torque transmitted from the rotary inertia mass damper 20 to the driven member 15 in the process of decreasing the relative displacement between the drive member 11 and the driven member 15, thereby ensuring vibration damping performance. In addition, a restriction of the movement of the ring gear 25 in the axial direction by the plurality of ring gear support portions 12rs and 13rs of the first and second input plates 12 and 13 prevents structures of the pinion gear 23 and the ring gear 25 from becoming complicated and prevents an assemblability of the damper device 10 with the rotary inertia mass damper 20 from being deteriorated. As a result, a cost increase of the damper device 10 with the rotary inertia mass damper 20 is suppressed while favorably ensuring the vibration damping performance.

Further, in the damper device 10, each of the outer teeth 15t of the driven member 15 that work as the sun gear of the rotary inertia mass damper 20, the pinion gears 23 and the ring gear 25 is the spur gear. This prevents a thrust in the axial direction from substantially acting on the ring gear 25 when the drive member 11 and the driven member 15 of the damper device 10 rotate. As a result, a frictional force generated between the ring gear 25 and the plurality of ring gear supporting portions 12rs and 13rs is reduced, such that the increase in the hysteresis of the rotary inertia mass damper 20 is favorably suppressed.

Further, in the damper device 10, the end face of each of the ring gear support portions 12rs and 13rs opposes to the side faces of the inner teeth 250t of the ring gear 25 with the slight clearance and each of the ring gear support portions 12rs and 13rs axially supports the side faces of the inner teeth 250t of the ring gear 25. This reduces the contact area between the ring gear 25 and the plurality of ring gear support portions 12rs and 13rs, such that the increase in the hysteresis of the rotary inertia mass damper 20 can be favorably suppressed.

Further, the first and the second input plates 12 and 13 are coupled to each other with the plurality of rivets 90 and each of the plurality of ring gear supporting portions 12rs and 13rs is disposed near the corresponding rivet 90. Each of the ring gear support portions 12rs and 13rs (bent portions) is disposed near a fastening portion of the first and the second input plates 12 and 13, such that rigidity around the fastening portion can be increased and the first and the second input plates 12 and 13 can be firmly connected. This suppresses deformations of the first and the second input plates 12 and 13 when the drive member 11 and the driven member 15 of the damper device 10 rotate, such that the increase in the hysteresis of the rotary inertia mass damper 20 can be favorably suppressed.

In the above damper device 10, the outer peripheral portions 12o and 13o of the first and second input plates 12 and 13 are formed to oppose to an entire side face of the ring gear 25 (weight body 251), but the damper device 10 is not limited to this. That is, as shown in FIG. 5, the outer peripheral surfaces 12o and 13o of the first and second input plates 12 and 13 may be formed such that outer peripheral surfaces thereof are located radially inward of an inner peripheral surface of the ring gear 25X (weight body 251). This configuration increases a width of the ring gear 25X, that is, the width of the weight body 251 so as to increase a mass of the ring gear 25X, thereby increase the inertia torque imparted from the ring gear 25X to the driven member 15 or the output element of the damper device 10.

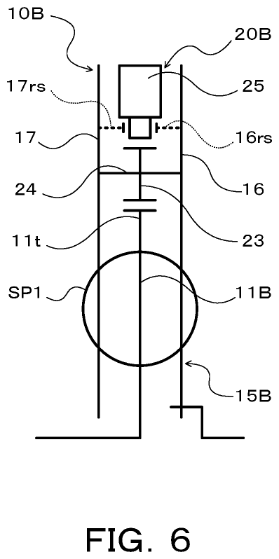

Further, the configuration related to an axial support of the ring gear 25 may be applied to the damper device 10B as shown in FIG. 6. The damper device 10B shown in FIG. 6 includes a drive member (input element) 11B that includes outer teeth 11t on an outer periphery and works as a sun gear of a rotary inertia mass damper 20B; a driven member 15B that includes first and second output plates 16 and 17 that support the plurality of pinion gears 23 meshing with the outer teeth 11t so as to work as a carrier of the rotary inertia mass damper 20B; first springs SP1 and second springs (not shown) that transmit a torque between the drive member 11B and the driven member 15B. In the damper device 10B, a plurality of ring gear supporting portions 16rs and a plurality of ring gear supporting portions 17rs, which are similar to the above ring gear support portions 12rs and 13rs, are arranged on an outer peripheral portion of the first or second output plates 16 and 17 of the driven member 15B. In the damper device 10B of FIG. 6, the drive member 11B is connected to a lock-up piston (not shown) via a connecting member that passes inside the first springs SP1 in the radial direction.

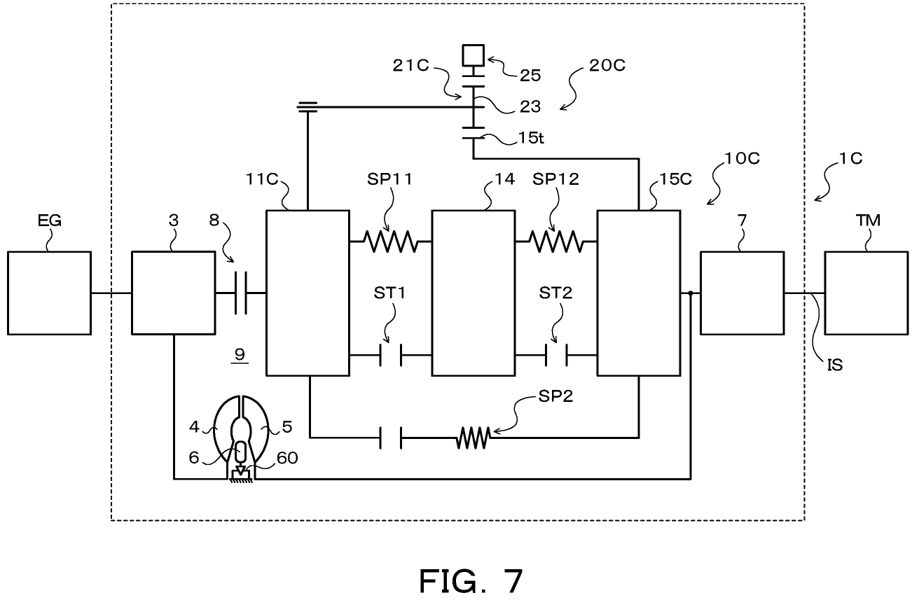

FIG. 7 is a schematic configuration diagram illustrating a starting device 1C including another damper device 10C according to the present disclosure. Among the components of the starting device 1C and the damper device 10C, the same components to those of the starting device 1 and the like described above are expressed by the same reference signs and their repeated description is omitted.

The damper device 10C shown in FIG. 7 includes a drive member (input element) 11C, an intermediate member (intermediate element) 14, and a driven member (output element) 15C as rotating elements. Further, the damper device 10C includes, a plurality of input side springs (input side elastic bodies) SP11 that transmits a torque between the drive member 11C and the intermediate member 14; a plurality of output side springs (output side elastic bodies) SP12 that transmits a torque between the intermediate member 14 and the driven member 15C; and a plurality of second springs (second elastic bodies) SP2 that transmits torque between the drive member 11C and the driven member 15C (as torque transmission elements (torque transmission elastic bodies)), a first stopper ST1 that restricts a relative rotation between the drive member 11C and the intermediate member 14, a second stopper ST2 that restricts a relative rotation between the intermediate member 14 and the driven member 15C, and a rotary inertia mass damper 20C.

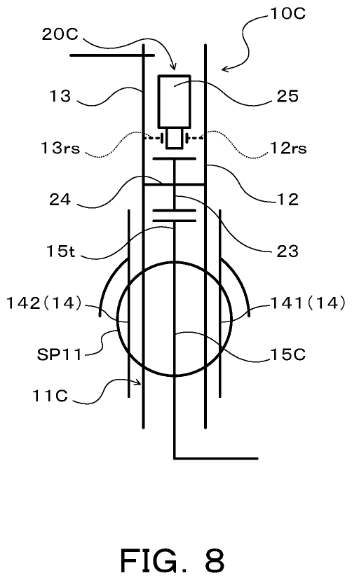

As shown in FIG. 8, the drive member 11C of the damper device 10C includes first and second input plates 12 and 13 that rotatably support the plurality of pinion gears 23 of a planetary gear 21C and work as a carrier of the rotary inertia mass damper 20C. The driven member 15C includes the outer teeth 15t on the outer circumference and works as a sun gear of the rotary inertia mass damper 20C (planetary gear 21). The intermediate member 14 includes a first intermediate plate 141 and a second intermediate plate 142. The first and second intermediate plates 141, 142 are coupled with each other by means of the plurality of rivets so as to hold the first and second input plates 12, 13, the driven member 15C, the plurality of input side springs SP11, the plurality of output side springs SP12, and the plurality of second springs SP2 from both sides in the axial direction of the damper device 10. In the damper device 10C, a plurality of ring gear support portions 12rs and a plurality of ring gear support portions 13rs are arranged on an outer peripheral portion of the first or second input plates 12 and 13 of the drive member 11C. This configuration enables a cost increase of the damper device 10C including the rotary inertia mass damper 20C to be suppressed while favorably ensuring vibration damping performance.

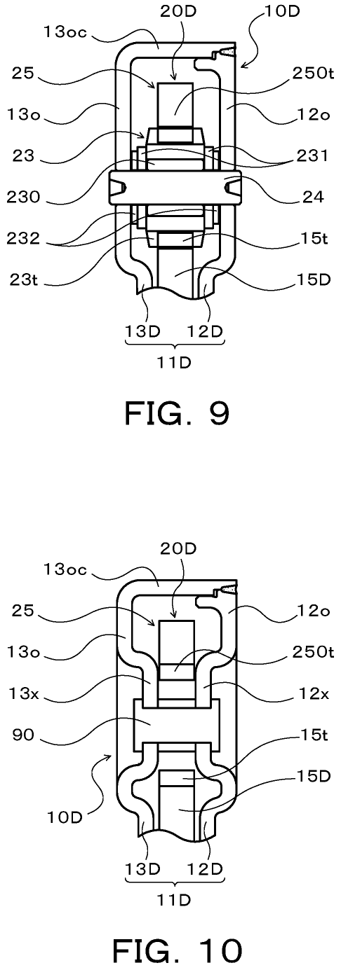

FIGS. 9 and 10 are enlarged views illustrating yet another damper device 10D according to the present disclosure. Among the components of the damper device 10D, the same components to those of the above damper device 10 and the like described above are expressed by the same reference signs and their repeated description is omitted.

The damper device 10D shown in FIGS. 9 and 10 is a unit that includes a drive member (input element) 11D, a driven member (output element) 15D, a plurality of unillustrated first and second springs (first and second elastic bodies) and a rotary inertia mass damper 20D. The damper device 10D is applied to a hybrid drive system including an engine and a motor, for example. The plurality of first springs of the damper device 10D works in parallel between the drive member 11D and the driven member 15 to transmit a torque. The plurality of second springs works in parallel with the plurality of first springs between the drive member 11D and the driven member 15D when a torsion angle of the drive member 11D with respect to the driven member 15D is equal to or more than a predetermined angle. Further, the rotary inertia mass damper 20D is configured by the driven member 15D that includes outer teeth 15t on an outer periphery and works as a sun gear; first and second input plates 12D and 13D of the drive member 11D that rotatably support the plurality of pinion gears 23 meshing with the outer teeth 15t so as to work as a carrier; and the ring gear 25 that meshes with each of the pinion gears 23 and is arranged concentrically with the driven member 15D (outer teeth 15t) as the sun gear.

In the damper device 10D, as shown in FIGS. 9 and 10, a cylindrical outer cylinder portion 13oc axially extends from the outer peripheral portion 13o of the second input plate 13D of the drive member 11D. A free end portion of the outer cylinder portion 13oc is joined (welded) to the outer peripheral portion 12o of the first input plate 12D. Thus, the first and second input plates 12D and 13D of the drive member 11D form a case (outer shell) of the damper device 10D that accommodates the first and the second springs, the driven member 15D, the rotary inertia mass damper 20D, and the like. A cylindrical outer cylindrical portion may extend in the axial direction from the outer peripheral portion 12o of the first input plate 12D of the drive member 11D, and the free end portion of the outer cylindrical portion may be joined (welded) to the outer peripheral portion of the second input plate 13D.

A plurality of dowels (protrusions) 12x are formed on the outer peripheral portion 12o of the first input plate 12D of the damper device 10D so as to axially protrude toward the second input plate 13D at intervals (at equal intervals) in the circumferential direction by pressing. Further, a plurality of dowels (protrusions) 13x are formed on the outer peripheral portion 13o of the second input plate 13D of the damper device 10D so as to axially protrude toward the first input plate 12D at intervals (at equal intervals) in the circumferential direction by pressing. The plurality of dowels 12x of the first input plate 12D respectively oppose to the corresponding dowels 13x of the second input plate 13D. As shown in FIG. 10, the dowels 12x and 13x opposing to each other are connected to each other by means of rivets 90. In the mounted state of the damper device 10D, a portion (contact portion) on the outer peripheral side of each of the dowels 12x of the first input plate 12D opposes to the one side faces (left side in the drawings) of the inner teeth 250t of the ring gear 25 with a slight clearance so as to come into contact with the one side faces. Similarly, in the mounted state of the damper device 10D, a portion (contact portion) on the outer peripheral side of each of the dowels 13x of the second input plate 13D opposes to the other side faces (right side in the drawings) of the inner teeth 250t of the ring gear 25 with a slight clearance so as to come into contact with the other side faces.

In the damper device 10D, at least one of the plurality of dowels 12x, 13x formed in each of the first and second input plates 12D and 13D to protrude in the axial direction at intervals in the circumferential direction comes into contact with the side faces of the inner teeth 250t of the ring gear 25 of the inertial mass damper 20D, thereby restricting the movement of the ring gear 25 in the axial direction. Further, in the damper device 10D, the ring gear 25 contacts only the dowels 12x and 13x and does not contact with any members other than the first and second input plates 12D and 13D that include the dowels 12x and 13x. As a result, the movement of the ring gear 25 in the axial direction can be restricted while reducing a contact area between the ring gear 25 and the plurality of dowels 12x and 13x, thereby suppressing an increase in a hysteresis of the rotary inertia mass damper 20D and ensuring vibration damping performance. In addition, a restriction of the movement of the ring gear 25 in the axial direction by the plurality of dowels 12x and 13x of the first and second input plates 12D and 13D prevents structures of the pinion gear 23 and the ring gear 25 from becoming complicated and prevents an assemblability of the damper device 10D with the rotary inertia mass damper 20D from being deteriorated. As a result, a cost increase of the damper device 10D with the rotary inertia mass damper 20D is suppressed while favorably ensuring the vibration damping performance.

The structure of the damper device 10D may be applied a damper device that includes a drive member (input element) including outer teeth on an outer periphery and working as a sun gear; and a driven member including first and second output plates that rotatably support a plurality of pinion gears respectively meshing with the outer teeth and work as a carrier. Further, the damper device 10D may include an intermediate member and a plurality of springs that transmit a torque between the intermediate member and the driven member 15D. Furthermore, the damper device 10D may be configured as a dry damper or a wet damper.

As has been described above, the damper device according to the present disclosure is a damper device (10, 10B, 10C, 10D) configured to include a plurality of rotational elements including an input element (11, 11B, 11C, 11D) to which a torque from an engine (EG) is transmitted and an output element (15, 15B, 15C, 15D), an elastic body (SP1 and SP2, SP11, SP12) arranged to transmit a torque between the input element (11, 11B, 11C, 11D) and the output element (15, 15B, 15C, 15D), and a rotary inertia mass damper (20, 20B, 20C, 20D) with a mass body (25, 25X) rotating in accordance with a relative rotation between a first rotational element which is one of the plurality of rotational elements and a second rotational element different from the first rotational element. The rotary inertia mass damper (20, 20B, 20C, 20D) includes a sun gear (15, 15C, 15t, 11B, lit) arranged to rotate integrally with the first rotational element, a plurality of pinion gears (23) rotatably supported by the second rotational element, and a ring gear (25, 25X) that meshes with the plurality of pinion gears (23) and works as the mass body. The second rotational element includes a plurality of ring gear supporting portions (12rs and 13rs, 12x, 13x, 16rs, 17rs) arranged at intervals in a circumferential direction so as to restrict a movement of the ring gear (25, 25X) in an axial direction of the damper device (10, 10B, 10C, 10D).

In the damper device of the present disclosure, the plurality of pinion gears of the rotary inertia mass damper is rotatably supported by the second rotational element in which the plurality of ring gear supporting portions is arranged at intervals in the circumferential direction so as to restrict a movement of the ring gear in an axial direction of the damper device. This enables the movement of the ring gear in the axial direction to be restricted while reducing a contact area between the ring gear and the plurality of ring gear support portions, thereby suppressing an increase in a hysteresis of the rotary inertia mass damper and ensuring vibration damping performance. Further, a restriction of the movement of the ring gear in the axial direction by the second rotating element prevents the structure of the ring gear and the pinion gear from becoming complicated and an assemblability of the damper device with the rotary inertia mass damper from being deteriorated. As a result, the cost increase of the damper device with the rotary inertia mass damper is suppressed while favorably ensuring vibration damping performance of the damper device.

Each of the plurality of ring gear supporting portions (12rs and 13rs, 12x, 13x, 16rs, 17rs) may include a contact portion configured to contact with the ring gear (25, 25X). The contact portion of each of the plurality of ring gear supporting portions contacts with the ring gear, such that the movement of the ring gear in the axial direction can be restricted.

Each of the plurality of ring gear supporting portions (12rs and 13rs, 12x, 13x, 16rs, 17rs) may be formed to protrude in the axial direction.

Each of the plurality of ring gear supporting portions (12rs and 13rs, 12x, 13x, 16rs, 17rs) may be either a bent portion or a dowel formed which protrudes in the axial direction.

Each of the sun gear (15, 15C, 15t, 11B, lit), the ring gear (25, 25X) and the pinion gear (23) may be a spur gear. This prevents a thrust in the axial direction from substantially acting on the ring gear when the rotating elements of the damper device rotate, thereby reducing a frictional force generated between the ring gear and the plurality of ring gear supporting portions and favorably suppressing the increase in the hysteresis of the rotary inertia mass damper.

Each of the plurality of ring gear supporting portions (12rs and 13rs, 16rs, 17rs) may support a side face of inner teeth (250t) of the ring gear (25, 25X) in the axial direction. This reduces a contact area between the ring gear and the plurality of ring gear support portions, such that the increase in the hysteresis of the rotary inertia mass damper can be favorably suppressed.

The second rotational element may include two plate members (12, 13, 12D, 13D, 16, 17) that are coupled to each other and oppose to each other along the axial direction so as to rotatably support the plurality of pinion gears (23). The two plate members may respectively include the plurality of ring gear supporting portions (12rs and 13rs, 12x, 13x, 16rs, 17rs).

The two plate members (12, 13, 12D, 13D, 16, 17) may be coupled to each other with a plurality of fastening members (90) arranged at intervals in the circumferential direction and each of the plurality of ring gear supporting portions (12rs and 13rs, 12x, 13x, 16rs, 17rs) is disposed in each of the two plate members (12, 13, 12D, 13D, 16, 17) so as to close to the corresponding fastening member (90). Each of the ring gear support portions is disposed near a fastening portion of the two plate members, such that rigidity around the fastening portion can be increased and the two plate members can be firmly connected. This suppresses a deformation of the two plate members when the rotating element of the damper device rotates, such that the increase in the hysteresis of the rotary inertia mass damper can be favorably suppressed.

The two plate members (12, 13, 12D, 13D, 16, 17) may respectively support an end portion of a pinion shaft (24) of the pinion gear (23). The plurality of fastening members (90) may be arranged on both sides of the pinion shaft (24) in the circumferential direction of the plate member (12, 13, 12D, 13D, 16, 17). The plurality of the ring gear supporting portions (12rs and 13rs, 12x, 13x, 16rs, 17rs) may be arranged in each of the two plate members (12, 13, 12D, 13D, 16, 17) so as to protrude in the axial direction radially outside the corresponding fastening member (90).

The second rotational member may be the input member (11, 11C, 11D). The second rotational member may be the output member (15B).

The output element (15, 15B, 15C, 15D) may be operatively (directly or indirectly) coupled with an input shaft (IS) of a transmission (TM).

The disclosure is not limited to the above embodiments in any sense but may be changed, altered or modified in various ways within the scope of extension of the disclosure. Additionally, the embodiments described above are only concrete examples of some aspect of the disclosure described in Summary and are not intended to limit the elements of the disclosure described in Summary.

### INDUSTRIAL APPLICABILITY

The techniques according to the disclosure is applicable to, for example, the field of manufacture of the damper device.

1. A damper device configured to include a plurality of rotational elements including an input element to which a torque from an engine is transmitted and an output element; an elastic body arranged to transmit a torque between the input element and the output element; and a rotary inertia mass damper with a mass body rotating in accordance with a relative rotation between a first rotational element which is one of the plurality of rotational elements and a second rotational element different from the first rotational element,
wherein the rotary inertia mass damper includes a sun gear arranged to rotate integrally with the first rotational element, a plurality of pinion gears rotatably supported by the second rotational element, and a ring gear that meshes with the plurality of pinion gears and works as the mass body, and
wherein the second rotational element includes a plurality of ring gear supporting portions arranged at intervals in a circumferential direction so as to restrict a movement of the ring gear in an axial direction of the damper device.

2. The damper device according to claim 1,
wherein each of the plurality of ring gear supporting portions includes a contact portion configured to contact with the ring gear.

3. The damper device according to claim 1,
wherein each of the plurality of ring gear supporting portions is formed to protrude in the axial direction.

4. The damper device according to claim 3,
wherein each of the plurality of ring gear supporting portions is either a bent portion or a dowel formed which protrudes in the axial direction.

5. The damper device according to claim 1,
wherein each of the sun gear, the ring gear and the pinion gear is a spur gear.

6. The damper device according to claim 1,
wherein each of the plurality of ring gear supporting portions supports a side face of inner teeth of the ring gear in the axial direction.

7. The damper device according to claim 1,
wherein the second rotational element includes two plate members that are coupled to each other and oppose to each other along the axial direction so as to rotatably support the plurality of pinion gears, the two plate members respectively including the plurality of ring gear supporting portions.

8. The damper device according to claim 7,
wherein the two plate members are coupled to each other with a plurality of fastening members arranged at intervals in the circumferential direction, and
wherein each of the plurality of ring gear supporting portions is disposed in each of the two plate members so as to close to the corresponding fastening member.

9. The damper device according to claim 8,
wherein the two plate members respectively support an end portion of a pinion shaft of the pinion gear,
wherein the plurality of fastening members is arranged on both sides of the pinion shaft in the circumferential direction of the plate member, and
wherein the plurality of the ring gear supporting portions is arranged in each of the two plate members so as to protrude in the axial direction radially outside the corresponding fastening member.

10. The damper device according to claim 1,
wherein the second rotational member is the input member.

11. The damper device according to claim 1,
wherein the second rotational member is the output member.

12. The damper device according to claim 1,
wherein the output element is operatively coupled with an input shaft of a transmission.
